(19) United States
(12) Patent Application Publication
(10) Pub. No.: US 2008/0039078 A1
(43) Pub. Date: Feb. 14, 2008

(54) Method and apparatus for transmitting and receiving electronic service guide for roaming user in a digital broadcasting system

(75) Inventors: Yiling Xu, Suwon-si (KR); Jae-Yeon Song, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/804,752

(22) Filed: May 18, 2007

Related U.S. Application Data
(60) Provisional application No. 60/801,081, filed on May 18, 2006.
(60) Provisional application No. 60/835,885, filed on Aug. 7, 2006.
(60) Provisional application No. 60/838,379, filed on Aug. 18, 2006.
(60) Provisional application No. 60/894,003, filed on Mar. 9, 2007.

(51) Int. Cl. H04Q 7/20

(52) U.S. Cl. 455/432.1

(57) ABSTRACT

A method and apparatus for transmitting and receiving an Electronic Service Guide (ESG) for roaming users in a Convergence of Broadcasting and Mobile Service (CBMS) system. A network entity generates a normal ESG indicating services available for local users in a network, and a special ESG indicating services available for roaming users in the network, the roaming users entering into the network from a neighboring network of the network, and transmits over at least one of an interactive network and a broadcast network the normal ESG and the special ESG to a terminal in the network. The terminal, or a roaming user, in the network receives the normal ESG and the special ESG, and performs a user roaming procedure or a service roaming procedure based on the special ESG.

### PRIORITY

This application claims priority under 35 U.S.C. § 119(a) to a United States patent application filed in the United States Patent and Trademark Office on May 18, 2006 and assigned Ser. No. 60/801,081, a United States patent application filed in the United States Patent and Trademark Office on Aug. 7, 2006 and assigned Ser. No. 60/835,885, a United States patent application filed in the United States Patent and Trademark Office on Aug. 18, 2006 and assigned Ser. No. 60/838,379, and a United States patent application filed in the United States Patent and Trademark Office on Mar. 9, 2007 and assigned Ser. No. 60/894,003, the disclosures of all of which are incorporated herein by reference.

### BACKGROUND OF THE INVENTION

1. Field of the Invention

The present invention relates generally to a digital broadcasting system, and in particular, to a method and apparatus for transmitting and receiving an Electronic Service Guide (ESG) for a roaming user in a Convergence of Broadcasting and Mobile Service (CBMS) system.

2. Description of the Related Art

Today, with the development of communication and broadcasting technologies, broadcasting systems or mobile communication systems can now provide mobile broadcasting, and discussions are being held not only on common broadcast service limited to the voice and video calls, but also on Mobile Broadcast (BCAST) that can transmit packet data over a broadcast channel. Mobile Broadcast can be achieved discovering a service by a mobile terminal capable of receiving Mobile Broadcast, like the mobile phone, notebook computer, Personal Digital Assistant (PDA), etc., subscribing to the service by the mobile terminal, provisioning a variety of control information for receiving the service, and transmitting and receiving the service by the mobile terminal.

Open Mobile Alliance (OMA), one of the groups assigned to study and research standards for interworking between individual mobile services, mainly takes charge of establishing various application standards for mobile games, Internet services, etc. Of the OMA working groups, OMA Browser and Content (BAC) BCAST Sub-Working Group is conducting extensive research on technology for converging broadcast services and mobile communication services using mobile terminals capable of communication with interactive networks. Also, Digital Video Broadcasting-Convergence of Broadcasting and Mobile Service (DVB-CBMS), one of the Mobile Broadcast terminal standard groups, defines system architectures and interfaces for converging the broadcast services and mobile communication services.

Generally, in the Mobile Broadcast system, a terminal for receiving a broadcast service receives a Service Guide (SG) that includes description information for the service itself, charging information for the service, and information on a reception method of the service, and receives an expected service using the service guide. A roaming procedure is utilized so that a terminal can move to the coverage (or service area) of a neighboring network belonging to another Internet Protocol (IP) platform, and leave the home network belonging to a single IP platform. Accordingly, there is a need for technology that can individually provide service guide information necessary for the terminal that has moved to the neighboring network through roaming, i.e. a roaming user.

### SUMMARY OF THE INVENTION

An aspect of the present invention is to address at least the problems and/or disadvantages and to provide at least the advantages described below. Accordingly, an aspect of the present invention is to provide a method and apparatus for transmitting and receiving an Electronic Service Guide (ESG) for a roaming user entered from another network.

Another aspect of the present invention is to provide a method and apparatus for transmitting and receiving to/from a roaming user a special ESG indicating available services for the roaming user.

According to one aspect of the present invention, there is provided a method for transmitting an Electronic Service Guide (ESG) for roaming users in a digital broadcasting system. The transmission method includes generating a normal ESG indicating services available for local users in a network; generating a special ESG indicating services available for roaming users in the network, the roaming users entering into the network from a neighboring network of the network; and transmitting the normal ESG and the special ESG to a terminal in the network over at least one of an interactive network and a broadcast network.

According to another aspect of the present invention, there is provided a method for receiving an Electronic Service Guide (ESG) for roaming users in a digital broadcasting system. The reception method includes receiving over at least one of an interactive network and a broadcast network a normal ESG indicating services available for local users in a network and a special ESG indicating services available for roaming users in the network, the roaming users entering into the network from a neighboring network of the network; and performing a user roaming procedure or a service roaming procedure depending on the special ESG.

According to further another aspect of the present invention, there is provided an apparatus for transmitting an Electronic Service Guide (ESG) for roaming users in a digital broadcasting system. The transmission apparatus includes an ESG entity for generating a normal ESG indicating services available for local users in a network, and a special ESG indicating services available for roaming users in the network, the roaming users entering into the network from a neighboring network of the network; and an interactive network and a broadcast network for transmitting the normal ESG and the special ESG to a terminal in the network.

According to yet another aspect of the present invention, there is provided an apparatus for receiving an Electronic Service Guide (ESG) for roaming users in a digital broadcasting system. The reception apparatus includes an interactive adaptor and broadcast receiver for receiving over at least one of an interactive network and a broadcast network a normal ESG indicating services available for local users in a network and a special ESG indicating services available for roaming users in the network, the roaming users entering into the network from a neighboring network of the network; and a control block for performing a user roaming procedure or a service roaming procedure depending on the special ESG.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram illustrating architecture of a CBMS system according to a preferred embodiment of the present invention;

FIG. 2 is a diagram illustrating roaming-related architecture based on the basic system architecture of FIG. 1, and logical function blocks in each entity;

FIG. 3 is a diagram illustrating a detailed roaming method between networks in the CBMS system;

FIG. 4 is a diagram conceptually illustrating delivery of a special ESG including service guide information of various types according to a preferred embodiment of the present invention;

FIGS. 5A and 5B are diagrams illustrating data models for delivering contents of a special ESG according to a preferred embodiment of the present invention;

FIG. 6 is a diagram illustrating a data model applicable to a special ESG according to a preferred embodiment of the present invention;

FIGS. 7A to 7C are diagrams illustrating three examples of a separated bootstrap structure for a normal ESG and a special ESG according to a preferred embodiment of the present invention;

FIG. 8 is a flowchart illustrating a roaming operation of a terminal performed using a special ESG according to an embodiment of the present invention;

FIG. 9 is a flowchart illustrating a roaming operation of a terminal performed using a special ESG according to another embodiment of the present invention;

FIG. 10 is a flowchart illustrating an operation of a network for delivering a special ESG according to an embodiment of the present invention;

FIG. 11 is a flowchart illustrating an operation of a network for delivering a special ESG according to another embodiment of the present invention;

FIGS. 12A to 12C are flowcharts illustrating message flows for performing a roaming procedure using a special ESG according to a preferred embodiment of the present invention;

FIG. 13 is a diagram illustrating architecture of a network according to a preferred embodiment of the present invention; and

FIG. 14 is a diagram illustrating architecture of a terminal receiver according to a preferred embodiment of the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention, as described herein, provides a method and apparatus for transmitting service guide information related to each of the available services expected for a terminal that has entered a present network from another network, i.e. a roaming user, through a separate Electronic Service Guide (ESG), in a Convergence of Broadcasting and Mobile Service (CBMS) system. An ESG for a roaming user will be referred to herein as a ‘special ESG’ to distinguish it from a normal ESG for a local user.

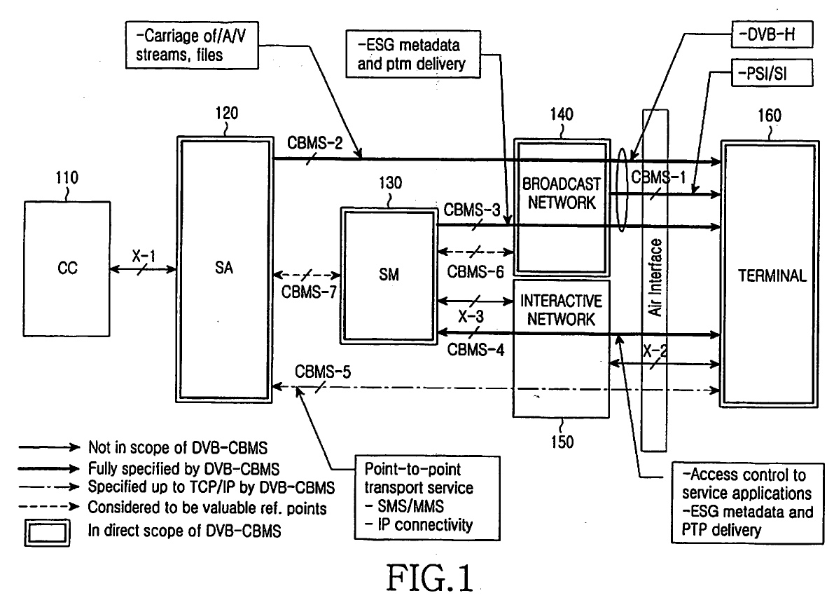

FIG. 1 illustrates architecture of a CBMS system according to a preferred embodiment of the present invention. Shown herein are logical entities that interwork with each other to achieve the capabilities required for Digital Video Broadcasting-Handheld (DVB-H) based IP Data Cast (IPDC). Although the entities are separately shown according to their major functions, they can be located in physically separated servers or in the same server.

Referring to FIG. 1, a Content Creation block (CC) 110 generates content sources of a broadcast service, and sends the content sources to a Service Application (SA) block 120. The Service Application block 120 generates service data for a specific service by aggregating the content sources provided from the Content Creation (CC) block 110 and the metadata additionally needed for service configuration. The Service Application block 120 is composed of several sub-entities that manage different applications for each service. A Service Management (SM) block 130 includes sub-entities that perform service configuration, resource allocation, ESG provisioning, security, Mobility Management (MM), etc. between the Service Application block 120 and a Terminal 160.

A Broadcast Network 140, a network for transmitting broadcast service data, is, for example, a DVB-H system. An Interactive Network 150 generally means a cellular mobile communication network such as a 3^{rd} Generation Partnership Project (3GPP) Universal Mobile Telecommunications system (UMTS) network, a 3GPP2 International Mobile Telecommunications (IMT)-2000 network, or a Wireless Broadband Internet (WiBro) network. As another example, the Interactive Network 150 can be any mobile communication network that provides a function capable of receiving information or a request transmitted from the Terminal 160 and transmitting a response to the information or request. The Broadcast Network 140 and the Interactive Network 150 serve as transmission bearers in the CBMS system.

The Terminal 160 is a user terminal, and indicates a receiver capable of accessing the Interactive Network 150 and receiving a broadcast service from the Broadcast Network 140. In the CBMS system, the Terminal 160 receives service data and signaling information from the Broadcast Network 140, and interactively communicates (exchanges) the service data and the signaling information with the Interactive Network 150.

A description will now be made of interfaces between entities including the logical entities described above. CBMS-x and X-x are reference points between different functional entities. CBMS-x is a reference point in the scope of IP Data Cast over DVB-H specification, and X-x is a reference point out of the scope of IP Data Cast over DVB-H specification.

X-1, X-2 and X-3 interfaces are reference points between the Broadcast Network 140 and other entities, and generally, these interfaces are not used in the DVB-H based interactive specification. The X-1 interface connects between the Content Creation block 110 and the Service Application block 120, the X-2 interface connects between the Interactive Network 150 and the Terminal 160, and the X-3 interface connects between the Service Management block 130 and the Interactive Network 150.

A CBMS-1 interface carries broadcast-related signaling from the Broadcast Network 140 to the Terminal 160, and a CBMS-2 interface carries content of audio, video, files, etc from the Service Application block 120 to the Terminal 160. A CBMS-3 interface carries an ESG on point-to-multipoint (ptm) from the Service Management block 130 to the Terminal 160 over the Broadcast Network 140, and a CBMS-4 interface carries an ESG in a Point-To-Point (PTP) transmission manner between the Service Management block 130 and the Terminal 160. A CBMS-5 interface is used for point-to-point (ptp) transport service between the Service Application block 120 and the Terminal 160, and carries Short Message Service (SMS) and Multimedia Message Service (MMS), etc. in a PTP transmission manner over the Interactive Network 150. A CBMS-6 interface carries configuration parameters such as the number of services, allocated bandwidth, etc. for DVB-H delivery between the Service Management block 130 and the Broadcast Network 140. A CBMS-7 interface carries a declaration of a service application, or metadata between the Service Application block 120 and the Service Management block 130.

The foregoing description has been made of the representative functions of the interfaces, by way of example, and the functions of the interfaces are not limited only to the description.

In the CBMS system, one service management instance is mapped to one IP platform. Therefore, ‘within one platform’ means ‘within one Service Management block 130’, and another IP platform means another service management block, i.e. means a service management block belonging to another network.

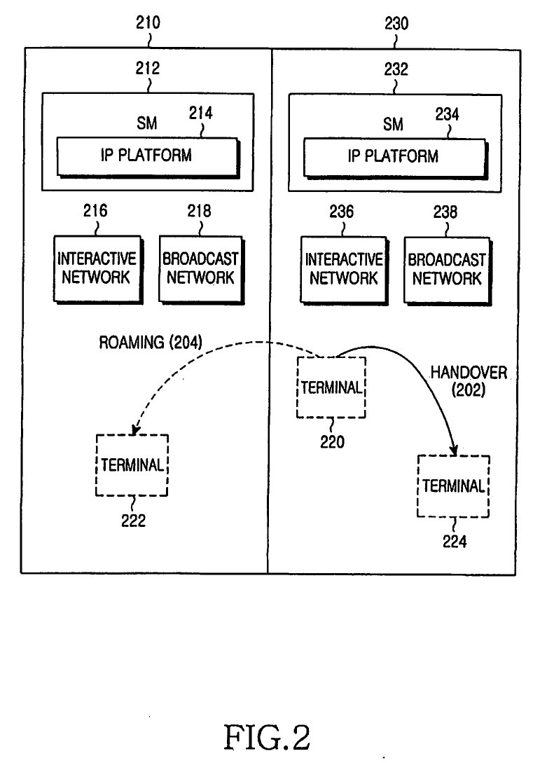

FIG. 2 illustrates roaming-related architecture based on the basic system architecture of FIG. 1, and logical function blocks in each entity.

Referring to FIG. 2, Service Management blocks 212 and 232 belong to different networks 210 and 230, respectively, and are mapped to their IP platforms 214 and 234. Further, the Service Management blocks 212 and 232 provide services and required signaling information to terminals in the corresponding networks 210 and 230 over Broadcast Networks 218 and 238, and communicate with the terminals in the corresponding networks 210 and 230 over Interactive Networks 216 and 236. If a Terminal 220 in the network 230 moves within the coverage of the home IP platform 234, as shown at 224, this corresponds to handover 202, and if the Terminal 220 moves to the coverage of the IP platform 214, as shown at 222, belonging to another network 210, this corresponds to roaming 204.

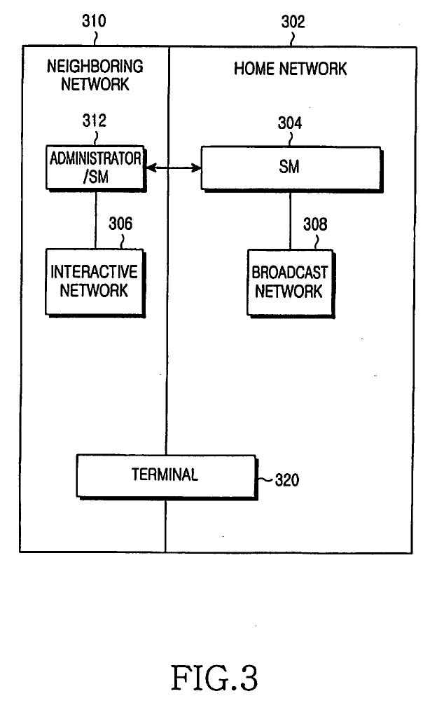

FIG. 3 illustrates a detailed roaming method between networks in the CBMS system.

Referring to FIG. 3, when a Terminal 320 capable of receiving a broadcast service over a Broadcast Network 308 managed by a Service Management block 304 in a home network 302 performs roaming to a neighboring network 310. The roaming of the Terminal 320 is supported in the neighboring network 310 over an Interactive Network 306. The Interactive Network 306 is managed by an Administrator or Service Management block 312 of the neighboring network 310. Specifically, the Interactive Network 306 is used for requesting and receiving a special ESG including service guide information for roaming users in the Interactive Network 306. Although a description of the present invention will be made on the assumption that the Interactive Network 306 is managed by the Service Management block 312, the following description can also be applied to the case where the Interactive Network 306 is managed by the Administrator 312.

There are two possible types of roaming—service roaming and user roaming—according to whether the service selected by a user accessing an IPDC service in a new IP platform other than the original IP platform is available in the new IP platform. The service roaming is supported when the selected service of the original IP platform can be received in the new IP platform, and the selected service is received over a transport stream provided by the new IP platform in the DVB-H network, or received over an interactive channel of the Interactive Network 306. The user roaming is supported when the selected service of the original IP platform cannot be received in the new IP platform, and a roaming user can access a service provided by the new IP platform other than the original IP platform.

In each network, an ESG for a local user, i.e. a normal ESG, is provided over a broadcast network on a free-to-air basis, and a user visiting from a neighboring network, i.e. a roaming user, can receive the normal ESG over the broadcast network of the current network, but the normal ESG may provide problems to the roaming user in correctly selecting an expected service. The special ESG provides service guide information for services expected for the roaming user.

Content of the special ESG, unlike the contents of the normal ESG, include service guide information for the following types, by way of example.

1. Information on some services or all services provided by the current network, which can be used by visiting users.

2. Information on the services, i.e. visited services, specially provided for visiting users by the current network. This information includes the information useful to the visiting users, like introduction of local map, service guidelines, local culture, local weather, etc. This information, being useful to the visiting users, supports a user roaming service of a special type. For example, a local map provided in the common language, i.e. English, other than the local language, is helpful in finding a location expected by the visiting users.

3. Information on the available service roaming from the home network. This information can be an ESG of the home network (i.e. home ESG), or can be the information on some home services available in the neighboring network.

Table 1A shows related information on the ‘user roaming’ service in the service type 1 for a special ESG.

TABLE 1A

| Service list | Related information |
|---|---|
| Each ‘user roaming’ | ServiceID |
| service | ProviderID |
| | IP address |
| | IP platform_id |
| | Service_id |
| | Transport stream_id |
| | Original network_id |
| | Cell_id |
| | Network_id |
| | Frequency information |
| | Right information |
| | Charging information |

Table 1B shows a service list for a ‘visited’ service in the service type 2 for a special ESG.

TABLE 1B

| Service list | Related information |
|---|---|
| Each ‘visited’ service | ServiceID |
| | ProviderID |
| | IP address |
| | IP platform_id |
| | Service_id |
| | Transport stream_id |
| | Original network_id |
| | Cell_id |
| | Network_id |
| | Frequency information |
| | Right information |
| | Charging information |

Table 1C shows a service list for a ‘service roaming’ service in the service type 3 for a special ESG.

TABLE 1C

| Service list | Related information |
|---|---|
| Each ‘service roaming’ | ServiceID |
| service | ProviderID |
| | IP address |
| | IP platform_id |
| | Service_id |
| | Transport stream_id |
| | Original network_id |
| | Cell_id |
| | Network_id |
| | Frequency information |
| | Right information |
| | Charging information |

A description will now be made of a difference between the ‘user roaming’ service and the ‘visited’ service. The ‘user roaming’ service, a service for a local user, is permitted even for a roaming user to support mobility. The ‘visited’ service is a service provided especially for a roaming user in the network, and its content and playback method are both in a form to satisfy requirements of the roaming user. For example, if a roaming user using English has entered a local area located in Germany, a map service for map information is provided in the local area by a German operator. When the map service is provided as a ‘user roaming’ service, the map information is provided in German, and even though the roaming user cannot fully understand the map information because of his/her language problem, the roaming user can use the map information. On the contrary, when the map service is provided as the ‘visited’ service, the map information is provided in English for the roaming user, and the roaming user can easily parse the map information. In addition, the map service can be provided in another service type for the local user or roaming user.

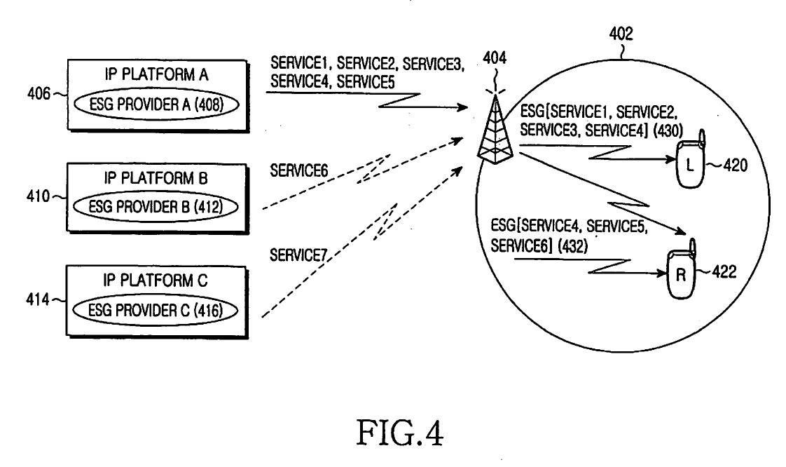

FIG. 4 conceptually illustrates delivery of a special ESG including service guide information of various types according to a preferred embodiment of the present invention.

Referring to FIG. 4, IP platforms 406, 410 and 414 belonging to their associated networks each have their own ESG providers 408, 412 and 416. The IP platform A 406 is providing Service 1 to Service 5, which are some of the available services, i.e. Service 1 to Service 7. Service 6 and Service 7 are provided in the IP platform B 410 and the IP platform C 414, respectively, both of which are adjacent to the IP platform A 406. The services that are available for a roaming user 422 are determined depending on a roaming agreement between networks.

Of the services provided for the local user 420 in the IP platform A 406, some services, for example, news, music, drama, etc. are shared by the roaming user 422. For example, although Service 1 to Service 4 are for a local user 420, Service 4 is permitted even for the roaming user 422 and this Service 4 corresponds to the ‘user roaming’ service in the service type 1 for a special ESG.

The IP platform A 406 especially provides a service for roaming user 422 to support mobility. This service for the roaming user 422, a content in which the roaming user 422 is especially interested, includes introduction for, for example, local map, local culture, local weather, etc. and is created in a language appropriate for the roaming user 422 so that it can be easily understood by the roaming user 422. In FIG. 4, Service 5 is provided especially for the roaming user 422 by the IP platform A 406. Service 5 corresponds to the ‘visited’ service in the service type 2 for a special ESG.

Some of the services provided in other IP platforms 410 and 414 are also provided even in the IP platform A 406 depending on the roaming agreement. For example, a service for stock news is retransmitted in the IP platform A 406 so that the roaming user 422 moving from the original IP platform may continually check the stock information. In FIG. 4, Service 6 from the IP platform B 410 is provided even in the IP platform A 406, for the roaming user 422 from the IP platform B 410. Service 6 corresponds to the ‘service roaming’ service in the service type 3 for a special ESG.

As described above, the services available for the roaming user 422 are guided after being classified according to type by a special ESG 432 for the roaming user 422, compared with a normal ESG 430 for the local user 420. The roaming user 422, if it enters a network of the IP platform A 406, receives the special ESG 432 from the corresponding network, selects an interested service by acquiring information on the services available for the roaming users referring to the special ESG 432, and performs a service access procedure according to the service type of the selected service.

A description will now be made of a detailed scheme for delivering a special ESG in a local network. The special ESG is provided over the broadcast network on a free-to-air basis, is delivered using encryption, or is delivered at the request of a terminal.

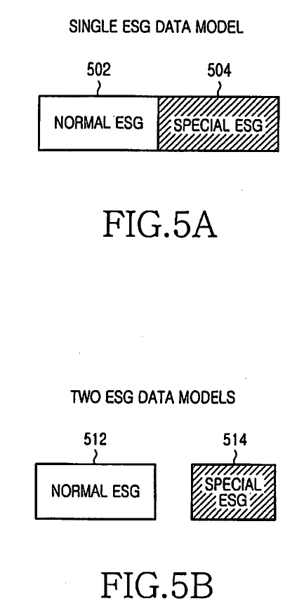

FIGS. 5A and 5B illustrate data models for delivering contents of a special ESG according to a preferred embodiment of the present invention. One of the data models of FIGS. 5A and 5B can be used according to a definition given in the broadcast standard, or according to a selection made by the ESG provider.

FIG. 5A illustrates an example of adding information elements for a special ESG 504 to a normal ESG 502, thereby using one ESG data model for both the normal ESG 502 and the special ESG 504. FIG. 5B illustrates an example of using two data models, wherein one ESG data model is for a normal ESG 512 and another ESG data model is for a special ESG 514. That is, the normal ESG 512 and the special ESG 514 use two different ESG data models.

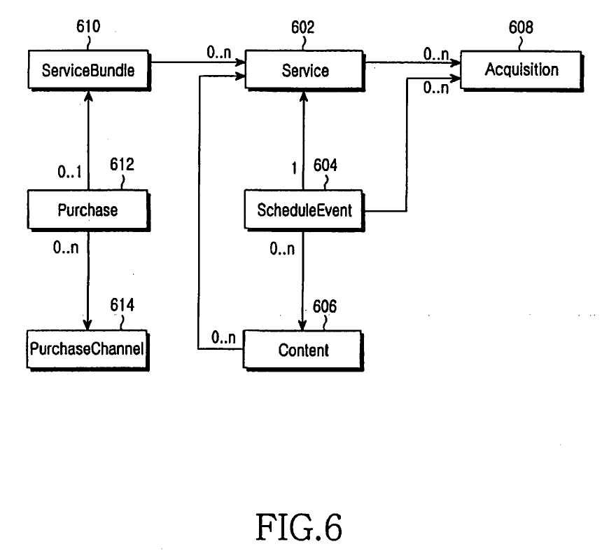

FIG. 6 illustrates a data model applicable to a special ESG according to a preferred embodiment of the present invention, wherein some of the information elements of the special ESG can be inserted into related fragments.

Referring to FIG. 6, shown blocks indicate fragments of ESG data. That is, an ESG data model is composed of a Service fragment 602, a Schedule Event fragment 604, a Content fragment 606, an Acquisition fragment 608, a Service Bundle fragment 610, a Purchase fragment 612, and a Purchase Channel fragment 614.

The Service fragment 602 includes a description of the entire service, and the Schedule Event fragment 604 indicates time information of the service. The Acquisition fragment 608 includes service access information that the terminal should acquire to receive service data, and the Service Bundle fragment 610 includes information where several services are bundled up into one service bundle. The Purchase fragment 612 provides price information used for purchasing the service bundle, and the Purchase Channel fragment 614 provides information on the system that the terminal should use to acquire a right for the purchase.

The fragments of the data model each can reference other fragments, and arrows between the fragments indicate the reference relationships. The term ‘reference’ as used herein refers to a process in which the current fragment provides information related to its own fragment using information transmitted in another fragment. That is, when one service is configured with several content, the Service fragment 602 includes only a description of the entire service, for example, a name of the service and a language of the service, but does not include a description of the content transmitted over the service. Simply, the Content fragment 606 of the corresponding content makes reference to the Service fragment 602. In acquiring various information that the terminal needs to receive the service, for example, acquiring session information used in a transmission protocol, the terminal can acquire the information by receiving and demodulating the Acquisition fragment 608 to which reference is made by the Service fragment 602.

The ESG data is separately transmitted to the terminal using at least one IP stream at a separate time from that of a data stream. Therefore, a service provider, before service delivery, can provide the information that the user should have before receiving the service, using an ESG data model. By receiving an ESG stream, the terminal acquires the information required for receiving the services provided by the service provider, and when the user selects a specific service, the terminal accesses the data stream over which the service is transmitted, using the acquired information, and then receives data. The information that the terminal needs to access the service data stream is transmitted over the Acquisition fragment 608, as described above.

The fragments of the ESG data model are contained in containers after some of the fragments are bundled for each container, and each container is regarded as one object in the File Delivery over Unidirectional Transport protocol (FLUTE) session during its delivery. For reception of an ESG, the terminal discovers ESG providers by accessing an ESG bootstrap FLUTE session that carries information necessary for ESG delivery, selects one of the ESG providers, and receives and parses a related ESG access descriptor from the selected ESG provider. When there is a service expected by the user, the terminal immediately accesses the ESG over the broadcast network depending on the ESG access descriptor.

A service ID for each service is specified in the Service fragment 602, an IP address is specified in the Acquisition fragment 608, and charging information is specified in the Purchase fragment 612. Service ID, transport stream ID, original network ID, cell ID, network ID, and frequency information are delivered over Program Specific Information and Service Information (PSI/SI), which is control information for a broadcast service.

There are two possible schemes of describing a service type (hereinafter referred to as a ‘roaming service type’) of a special ESG. A first scheme additionally specifies the roaming service type in the existing service type field, and the second scheme includes in the Service fragment 602 a new information element for describing the roaming service type.

When the roaming service type is additionally specified in the service type field, elements of Table 2A or Table 2B are added.

```
TABLE 2A
  <ClassificationScheme
uri=“urn:dvb:ipdc:esg:cs:RoamingServiceTypeCS:>
  <Term termID=“1.0”<Name xml:lang=“en”> Roaming Service
Type</Name>
    <Definition xml:lang=“en”>Type of roaming service, e.g. user
roaming, visited service, service roaming</Definition>
    <Term termID=“1.1>
      <Name xml:lang=“en”>User roaming</Name>
      <Definition xml:lang=“en”>A User roaming service</Definition>
  <Term termID=“1.2>
      <Name xml:lang=“en”>Visited service</Name>
      <Definition xml:lang=“en”>A Visited service</Definition>
  <Term termID=“1.3>
      <Name xml:lang=“en”>Service roaming</Name>
    <Definition xml:lang=“en”>A Service roaming service</Definition>
```

```
TABLE 2B
  <ClassificationScheme
uri=“urn:dvb:ipdc:esg:cs:RoamingServiceTypeCS:>
  <Term termID=“1.0”<Name xml:lang=“en”> Roaming Service
Type</Name>
    <Definition xml:lang=“en”>Type of roaming service, e.g. user
roaming, visited service, service roaming</Definition>
    <Term termID=“1.1>
      <Name xml:lang=“en”>User roaming</Name>
      <Definition xml:lang=“en”>A User roaming service</Definition>
  <Term termID=“1.2>
      <Name xml:lang=“en”>Visited service</Name>
      <Definition xml:lang=“en”>A Visited service</Definition>
  <Term termID=“1.3>
      <Name xml:lang=“en”>Service roaming</Name>
    <Definition xml:lang=“en”>A Service roaming service</Definition>
```

For identification of the roaming service types, different bits can be used such that ‘01’ is used for the ‘user roaming’ service, ‘10’ is used for the ‘visited’ service, and ‘11’ is used for the ‘service roaming’ service. When there is a further need for additional types other than the three roaming service types given above, additional bits can be used to distinguish the roaming service types.

For the ‘service roaming’ service, because the original IP platform or network that has provided the corresponding service should be indicated, there is a need for a new information element for the ‘service roaming’ service, shown in Table 3. The information element for the ‘service roaming’ service can be added to the service fragment, the acquisition fragment, or another fragment of the ESG data model.

```
TABLE 3
  <complexType name = “service roaming service” minOccur=“0”
maxOccur=“unbounded”>
  <all>
  <element name=“home IP platform_id” type=“anyURI”>
  <element name=“home IP address” type=“anyURI”>
  <element name=“home providerID” type=“anyURI”>
  <element name=“home serviceID” type=“anyURI”>
  <element name=“home network_id” type=“anyURI”>
  <element name=“interactive network” type=“esg: interactive network”>
  </all>
  </complexType>
```

In Table 3, “interactive network” means interactive network information needed when an interactive network is used to deliver a service from a home network to a visited network due to service roaming. The interactive network information is configured as shown in Table 4, and is provided to the terminal over an information element of the ‘service roaming’ service, the service fragment, or the acquisition fragment.

```
TABLE 4
    <complex Type name=“interactive network” minOccurs = “0”
maxOccurs=“unbounded”/>
    <all>
      <element name=“InteractiveNetworkProvider”type=“anyURI”>
      <element name=“AcquisitionRef”type=“anyURI”>
      <element name=“InteractiveEntrypoint”type=“anyURI”>
      <element name=“
InteractiveNetworkTypeRef”type=“InteractiveNetworkType”>
    </all>
    </complex type>
```

In Table 4, “InteractiveEntrypoint” indicates an entry point for the interactive network used for service roaming, and can be a Uniform Resource Locator (URL) of a web site, or a phone number used in the interactive network.

Because the interactive network can be classified into various types such as 3GPP, 3GPP2, WibRo, etc., the interactive network information describes the interactive network types as shown in Table 5.

TABLE 5

```
<simpleType name=“InteractiveNetworkType”>
<restriction base=“string”>
      <enumeration value=“3GPP”/>
      <enumeration value=“3GPP2”/>
      <enumeration value=“WLAN”/>
      <enumeration value=“WIBRO”/>
</restriction>
</simpleType>
```

The Right information shown in Tables 1A to 1C is used for determining whether the user has a right to consume the roaming service. According to a roaming agreement between two networks (IP platforms), a specific user group from some networks can directly consume the specific service, but other users should first purchase the specific service. An information element for the Right information is shown in Table 6.

TABLE 6

```
    <complexType name = RightInformtion” minOccur=“0”
maxOccur=“unbounded”>
    <all>
    <element name=“group_id” type=“anyURI”>
    <element name=“IP platform_id” type=“anyURI”>
    <element name=“network_id” type=“anyURI”>
    <element name=“Protection” type=“Boolean” >
    <<element name=“ProtectionRef” type=“Boolean” >
    </all>
    </complexType>
```

In Table 6, group ID, IP platform ID and network ID indicate for which user group from which IP platform or network the Right information is to be provided. When the corresponding service can be directly accessed, “Protection” is set as “false,” and otherwise, “Protection” is set as “true.” The information related to acquisition of a right makes reference to “ProtectionRef.” The information element for Right information is included in the service fragment or the purchase fragment, or included in another fragment of the ESG data model.

When the terminal intends to perform roaming to a neighboring network using a special ESG, the terminal determines which service is available through roaming, by parsing the special ESG. To this end, the terminal first finds an entry point for the special ESG.

As an example, when the terminal acquires an ESG bootstrap address from PSI/SI and an ESG is free-to-air, the terminal determines an entry point (i.e. IP address) for the special ESG from the ESG bootstrap information acquired using the ESG bootstrap address. The ‘ESG bootstrap information’ as used herein refers to the information necessary for the reception of an ESG, and includes ESG bootstrap data delivered through an ESG bootstrap protocol. By processing the ESG bootstrap information, the terminal acquires a variety of information necessary for receiving the ESG.

However, if the ESG is not free to air, the terminal sends a request for a special ESG to an ESG provider, and access information for the ESG provider is provided as the ESG bootstrap information. After authentication, the ESG provider provides a special ESG to the terminal. For example, the special ESG is directly transmitted to the terminal over the interactive network, or a key for an encrypted special ESG is transmitted to the terminal.

ESG bootstrap information for a special ESG (hereinafter referred to as ‘special-ESG bootstrap information’) is indicated by adding a new information element referred to as “special-ESG bootstrap information (special-ESG bootstrap)” in “ESG Provider Discovery Descriptor” or “ESG Access Descriptor,” or by adding therein a new descriptor referred to as “special-ESG Bootstrap Descriptor.”

The special-ESG bootstrap information can be transmitted separately from the ESG bootstrap information for a normal ESG (hereinafter referred to as ‘normal-ESG bootstrap information’). In particular, a special ESG for mobility information can be gathered from different ESG providers of the IP platform.

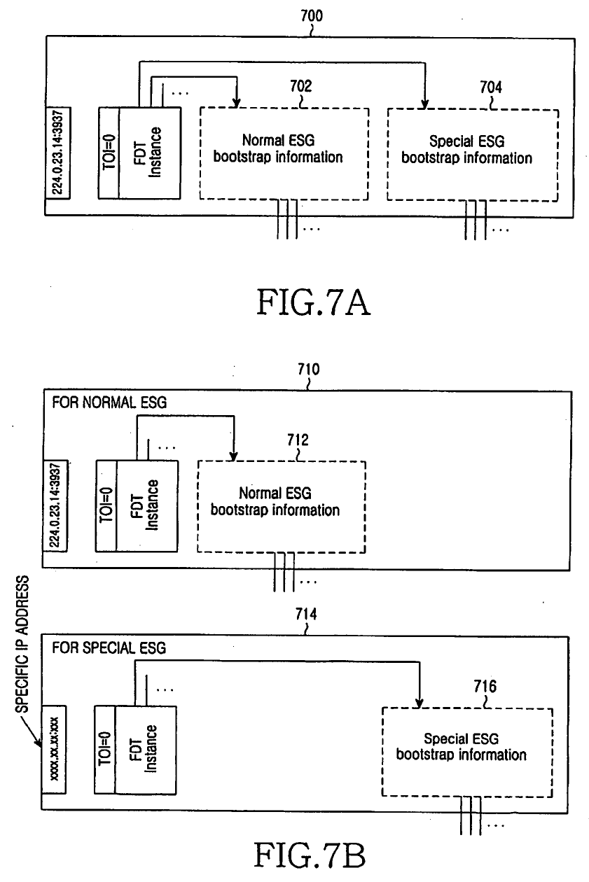

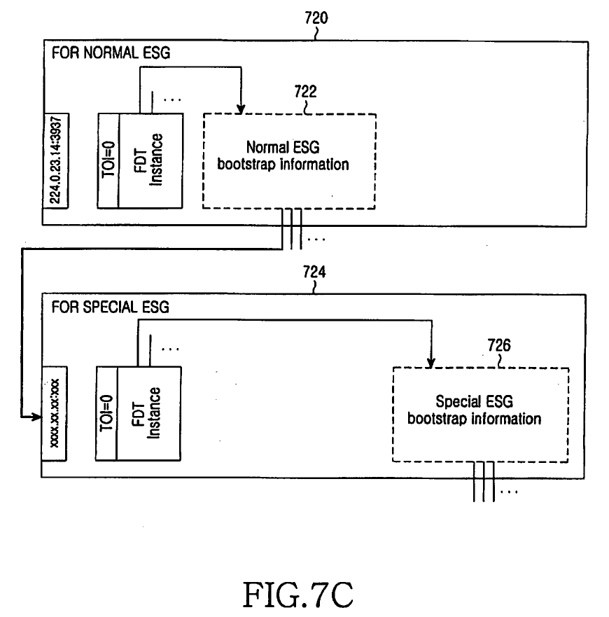

FIGS. 7A to 7C illustrate three examples of a separated bootstrap structure for a normal ESG and a special ESG according to a preferred embodiment of the present invention.

FIG. 7A illustrates a separated bootstrap structure for the case where a normal ESG and a special ESG are delivered using one ESG data model. In this bootstrap structure, normal-ESG bootstrap information 702 and special-ESG bootstrap information 704 are both delivered over a common ESG bootstrap session 700.

FIGS. 7B and 7C illustrate separated bootstrap structures for the case where a normal ESG and a special ESG are delivered using different ESG data models.

In the bootstrap structure of FIG. 7B, normal-ESG bootstrap information 712 is delivered over an ESG bootstrap session 710 for a normal ESG, and special-ESG bootstrap information 716 is delivered over an ESG bootstrap session 714 for a special ESG. Herein, a specific IP address indicating the ESG bootstrap session 714 for a special ESG is fixedly determined, or acquired through PSI/SI, by way of example.

In the bootstrap structure of FIG. 7C, normal-ESG bootstrap information 722 is delivered over an ESG bootstrap session 720 for a normal ESG, and special-ESG bootstrap information 726 is delivered over an ESG bootstrap session 724 for a special ESG. An IP address indicating the ESG bootstrap session 724 for a special ESG is indicated herein by the normal-ESG bootstrap information 722.

A delivery scheme of a special ESG indicated by the special-ESG bootstrap information can be achieved over a broadcast network or an interactive network. Also, the special ESG can be encrypted for security.

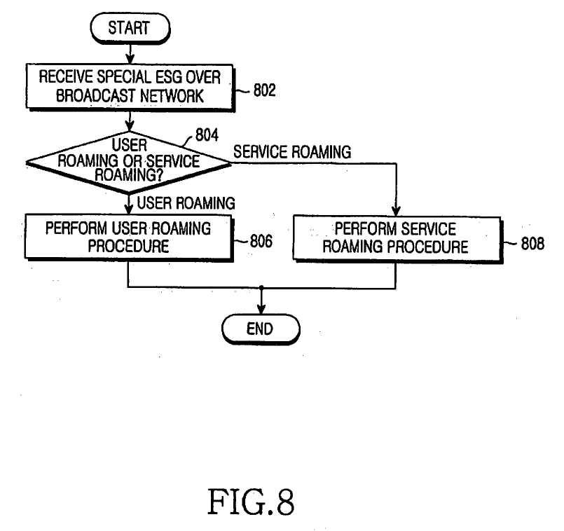

FIG. 8 illustrates a roaming operation of a terminal performed using a special ESG according to an embodiment of the present invention. The operation is shown herein for the case where the special ESG is free-to-air.

Referring to FIG. 8, in step 802, the terminal, while entering the coverage of a visited network, receives a special ESG over a broadcast network or another means of the visited network. In step 804, the terminal determines the services available for roaming users in the visited network referring to the special ESG, to determine whether it will perform user roaming or service roaming. Herein, the user roaming is selected when the user of the terminal cannot receive an expected service in the visited network, and the service roaming is selected when the expected service can be received in the visited network. Based on the determination of step 804, a user roaming procedure is performed in step 806, or a service roaming procedure is performed in step 808. A detailed description of the user or service roaming procedure will be omitted herein because it is not related to the understanding of the present invention. In the service roaming procedure, the terminal sends a request for the expected service to the network. However, in the user roaming procedure, the terminal does not need to send a request for the expected service to the network.

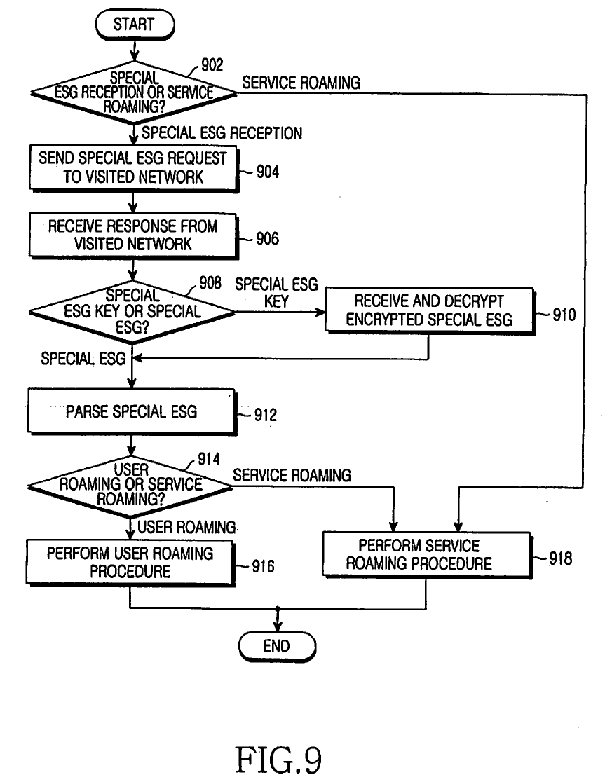

FIG. 9 illustrates a roaming operation of a terminal performed using a special ESG according to another embodiment of the present invention. In this operation, the special ESG is not free to air, and it is delivered over a broadcast network or an interactive network after being encrypted, or delivered only at the request of the user. This delivery scheme of the special ESG is determined according to a definition in the standard or a selection by the network.

Referring to FIG. 9, in step 902, the terminal determines whether it will immediately start service roaming, or it will first check a special ESG. If the user selects an immediate start of the service roaming or the terminal perceives the availability of the service roaming, the terminal proceeds to step 918 where a service roaming procedure is performed. However, if the terminal intends to first check the special ESG, the terminal sends to a visited network a request for a special ESG in step 904, and receives from the visited network in step 906 a response to the request for the special ESG. The request and response for the special ESG are delivered over an interactive network. Here, in step 906, the special ESG itself is received or a key used for acquiring the special ESG is received as the response according to a definition in the standard or a selection by the network.

Therefore, the terminal determines in step 908 whether the response is the special ESG or the key, and if the received response is the key, the terminal proceeds to step 910 where it receives an encrypted special ESG from the broadcast network and acquires a non-encrypted special ESG by decrypting the encrypted special ESG using the key, and then proceeds to step 912. However, if the received response is the special ESG, the terminal directly proceeds to step 912 where the terminal parses the special ESG.

In step 914, the terminal determines the services available for roaming users in the visited network referring to the special ESG, to determine whether it will perform user roaming or service roaming. Based on the determination of step 914, a user roaming procedure is performed in step 916, or a service roaming procedure is performed in step 918.

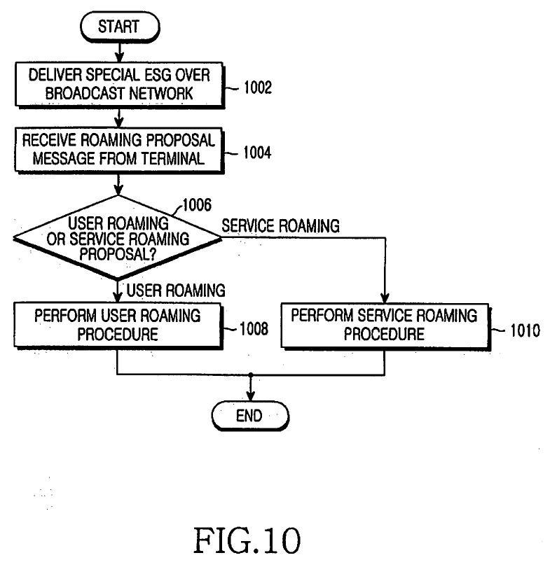

FIG. 10 illustrates an operation of a network for delivering a special ESG according to an embodiment of the present invention. The operation is shown herein for the case where the special ESG is free-to-air. The operations described below are performed by an ESG provider in the network, and a network entity for mobility management.

Referring to FIG. 10, in step 1002, a special ESG is delivered over a broadcast network or another means on a free-to-air basis. If a roaming proposal message is received from a terminal in step 1004, the network entity determines in step 1006 whether the roaming proposal message requests a user roaming procedure or requests a service roaming procedure. Based on the determination of step 1006, the user roaming procedure is performed in step 1008, or the service roaming procedure is performed in step 1010.

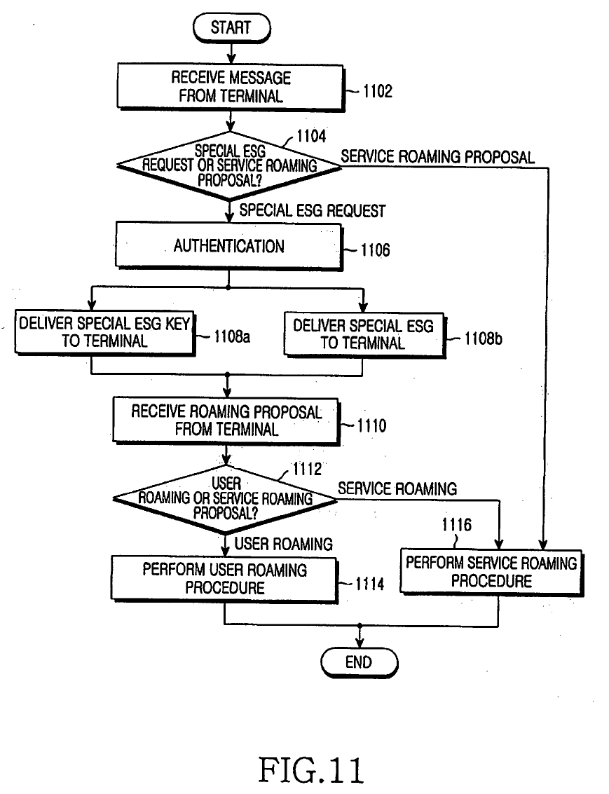

FIG. 11 illustrates an operation of a network for delivering a special ESG according to another embodiment of the present invention. In this operation, the special ESG is not free-to-air, and is delivered at the request of the terminal.

Referring to FIG. 11, the network entity receives a message from a terminal in step 1102, and determines in step 1104 whether the received message is a request for a special ESG or a service roaming proposal message. If the received message is the service roaming proposal message, the network entity proceeds to step 1116 where a service roaming procedure is performed. However, if the received message is the request for a special ESG, the network entity performs in step 1106 an authentication procedure for the terminal and determines that the terminal is an authenticated user. After completion of the authentication procedure, the network entity, according to a definition in the standard or a selection by the network, delivers in step 1108a a key necessary for acquiring the special ESG to the terminal over the interactive network, or delivers in step 1108b the special ESG over the interactive network. In step 1108a, the special ESG, which is encrypted so that it can be decrypted with the key, is delivered over the broadcast network.

After delivering the key or the special ESG, if a roaming proposal message is received from the terminal in step 1110, the network entity determines in step 1112 whether the roaming proposal message requests service roaming or requests user roaming. Based on the determination of step 1112, a user roaming procedure is performed in step 1114, or a service roaming procedure is performed in step 1116.

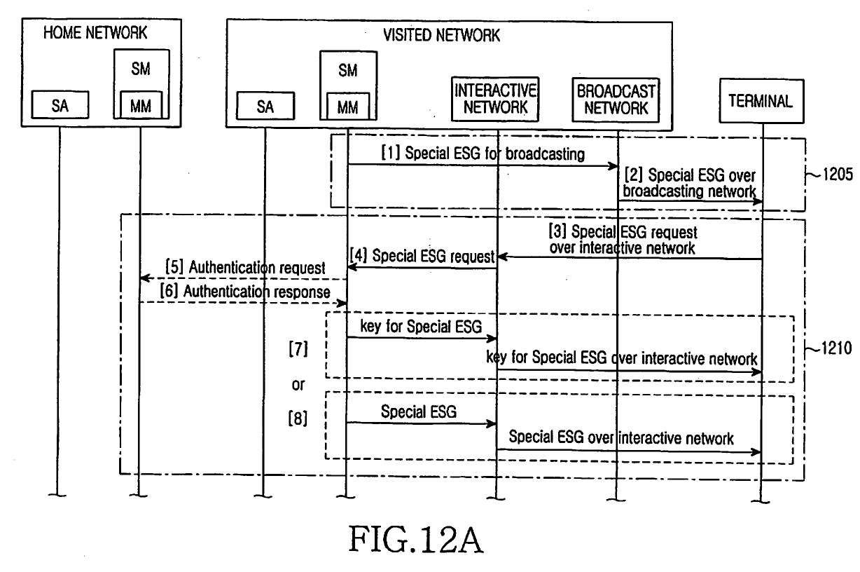

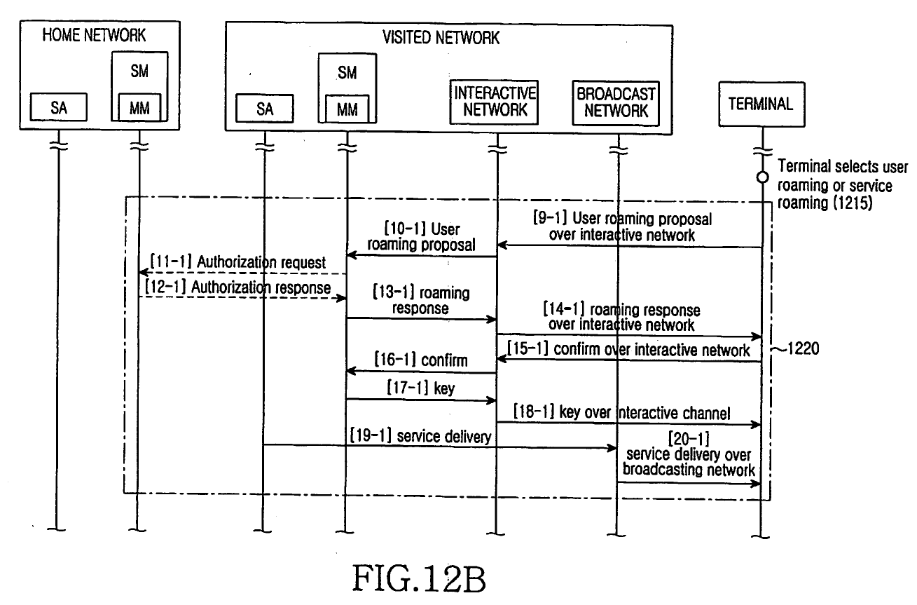

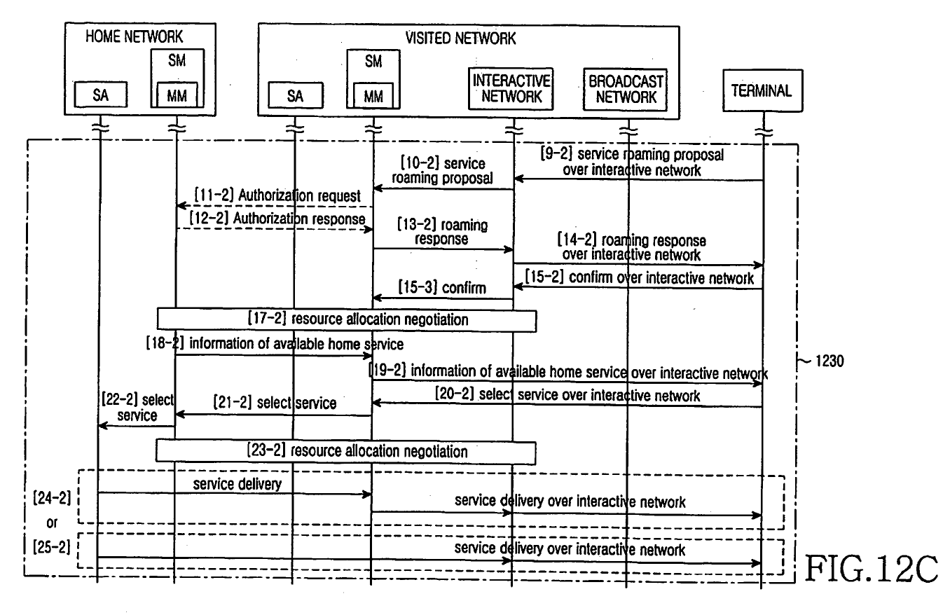

FIGS. 12A to 12C illustrate message flows for performing a roaming procedure using a special ESG according to a preferred embodiment of the present invention. A Service Management (SM) block of each network includes a Mobility Management (MM) block to support the terminals moving between networks. The MM block herein controls the mobility management including the roaming and handover processes. For roaming, the MM block transmits/receives a roaming request and a roaming response, communicates with other entities and its sub-entities to support the roaming process, and includes a function of communicating with MM blocks in other networks for roaming information.

Referring to FIG. 12A, process 1205 indicates an instance where a special ESG is delivered over a broadcast network. In this instance, to support a terminal of a roaming user who has moved from a home network to a visited network, an MM block in the visited network (hereinafter referred to as a ‘visited MM block’) generates a special ESG for broadcasting, and delivers the special ESG to a broadcast network in step [1]. The special ESG is delivered to the terminal over the broadcast network in step [2]. The special ESG, as described above, includes information on the services available for roaming users in the network. When the special ESG is delivered on a free-to-air basis, the terminal parses the special ESG without any separate information, and then proceeds to process 1215 of FIG. 12B. However, if the special ESG is not free-to-air, the special ESG cannot be parsed as it is encrypted. Therefore, the terminal proceeds to process 1210.

Process 1210 indicates an instance where the special ESG is not free-to-air. In this instance, the terminal that has entered the visited network sends a special ESG request message to the visited MM block over the interactive network as shown in steps [3] and [4]. An exemplary format of the special ESG request message is shown in Table 7.

TABLE 7
Special ESG Request Message

| Name | Description |
|---|---|
| Special ESG | Identifier for special ESG request message |
| request ID | |
| User ID | The user identity |
| Home network ID | Home network identity |
| Home IP | Home IP platform identity |
| platform_id | |
| Roaming key | Depending on the roaming agreement between the |
| (optional) | home and visited networks, the roaming key can be |
| | used to request roaming in the visited network. |

The visited MM block, when necessary, sends an authentication request for the terminal to an MM block in the home network (hereinafter referred to as a ‘home MM block’) to which the terminal has moved, in response to the special ESG request message in step [5], and receives an authentication response to the authentication request in step [6]. If the terminal is successfully authenticated by the authentication request and the authentication response, the visited MM block delivers a key for the special ESG to the terminal over the interactive network in step [7], or delivers the special ESG to the terminal over the interactive network in step [8]. If the terminal has already received the special ESG in process 1205, the terminal has no need to re-receive the special ESG over the interactive network. However, if the special ESG received over the broadcast network in process 1205 is encrypted, the terminal decrypts the special ESG using the key.

An exemplary format of a key delivery message used to deliver the key in step [7] is shown in Table 8.

TABLE 8
Key Delivery Message for Special ESG

| Name | Description |
|---|---|
| Key for special | Identifier for key for special ESG message |
| ESG ID | |
| Visited network | ID for the visited network. |
| ID | |
| Visited IP | Visited IP platform identity |
| platform_id | |
| Key | Key for special ESG |
| Charging | Corresponding charging information |
| (optional) | |
| Rights (optional) | Information about how to get the rights of service |
| | consuming. |

An exemplary format of a special ESG delivery message used to deliver the special ESG in step [8] is shown in Table 9.

TABLE 9
Special ESG Delivery Message

| Name | Description |
|---|---|
| Special ESG ID | Identifier for special ESG message |
| Visited network | ID for the visited network. |
| ID | |
| Special ESG | ESG that is specially for the roaming information |
| Charging | Corresponding charging information |
| (optional) | |
| Rights (optional) | Information about how to get the rights of service |
| | consuming. |

Referring to FIG. 12B, in process 1215, the terminal checks the services available for roaming users in the visited network referring to the special ESG, and determines whether it will perform user roaming or service roaming. Based on the determination of process 1215, a user roaming procedure is performed in process 1220, or a service roaming procedure is performed in process 1230 of FIG. 12C.

A detailed description of process 1220 will now be made.

The terminal sends a user roaming proposal message indicating its expected service to the visited MM block over the interactive network in steps [9-1] and [10-1], and the visited MM block, when necessary, sends an authentication request for the terminal to the home MM block in response to the user roaming proposal message in step [11-1], and receives an authentication response to the authentication request in step [12-1]. If the terminal is successfully authenticated by the authentication request and the authentication response, the visited MM block sends a roaming response message to the terminal over the interactive network in steps [13-1] and [14-1], and receives a confirm message for user roaming from the terminal in steps [15-1] and [16-1]. Upon receipt of the confirm message, the visited MM block delivers a roaming key for user roaming to the terminal over the interactive network in steps [17-1] and [18-1]. The roaming key is used for decrypting the service that the terminal receives from the visited network. The service expected by the terminal is delivered from a Service Application (SA) block in the visited network over the broadcast network in steps [19-1] and [20-1].

A detailed description will now be made of process 1230.

Referring to FIG. 12C, the terminal sends a service roaming proposal message indicating the service being received in the home network, to the visited MM block over the interactive network in steps [9-2] and [10-2], and the visited MM block, when necessary, sends an authentication request for the terminal to the home MM block in response to the service roaming proposal message in step [11-2], and receives an authentication response to the authentication request in step [12-2]. If the terminal is successfully authenticated by the authentication request and the authentication response, the visited MM block sends a roaming response message to the terminal over the interactive network in steps [13-2] and [14-2], and receives a confirm message for service roaming from the terminal in steps [15-2] and [16-2].

Upon receipt of the confirm message, the visited MM block receives information on the available home services from the home MM block in step [18-2], and provides information on the available home services to the terminal over the interactive network in step [19-2]. The terminal reports a service selected depending on the information, to the visited MM block over the interactive network in step [20-2], and the visited MM block notifies the service selected by the terminal, to the home MM block and an SA block in the home network (hereinafter referred to as a ‘home SA block’) in steps [21-2] and [22-2]. During the user roaming procedure, after the confirm message is received, or after the selected service is notified to the home SA block, resource allocation negotiation for service roaming is achieved between the home network and the visited network in steps [17-2] or [23-2]. The service selected by the terminal is delivered from the home SA block over the interactive network under the control of the visited MM block in step [24-2], or is delivered from the home SA block over the interactive network in step [25-2].

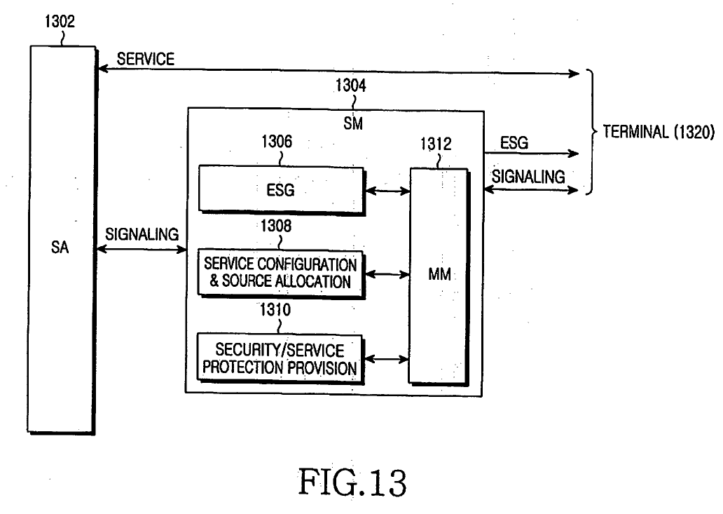

FIG. 13 illustrates architecture of a network according to a preferred embodiment of the present invention. Shown are the entities for performing the logical functions related to the preferred embodiment of the present invention in the network.

Referring to FIG. 13, a Service Application (SA) block 1302 generates service data by aggregating related metadata and broadcast content from multiple sources to provide a specific service, encodes the service data in the format interpretable by a terminal, provides the coded service data to the terminal through streaming or file carrousel delivery, and generates metadata including a service description to be used for an ESG. The SA block 1302 separately provides metadata for the services of the foregoing service types, being available especially for roaming users, such that it can be used in generating a special ESG.

An ESG entity 1306 in a Service Management (SM) block 1304 generates an ESG using the metadata provided from the SA block 1302, and delivers the generated ESG. Specifically, the ESG entity 1306, as described above, generates each ESG by gathering metadata related to a normal ESG and a special ESG, and the ESGs are delivered to a Terminal 1320 over a broadcast network and/or an interactive network by means of an MM block 1312. When necessary, the ESG entity 1306 generates a key for the special ESG, and delivers the key to the Terminal 1320.

A Service Configuration & Resource Allocation entity 1308, which is responsible for service configuration and allocation of network resources, contends for bandwidth of broadcast bearers through communication with the SA block 1302, and allocates services in positions of a broadcast network topology. Also, the Service Configuration & Resource Allocation entity 1308 determines service bandwidth, and schedules service time. A Security/Service Protection Provision entity 1310 is responsible for security/authentication, service protection, and service provisioning. The entities 1306 to 1310 are connected to the MM block 1312 to perform the functions necessary for handover. The MM block 1312 performs operations related to the mobility of the terminal, especially to handover and roaming.

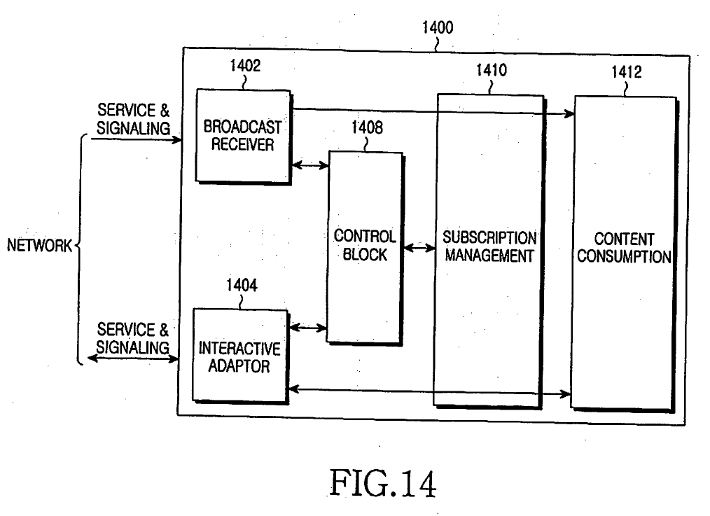

FIG. 14 illustrates architecture of a terminal receiver according to a preferred embodiment of the present invention.

Referring to FIG. 14, a receiver 1400 includes not only a broadcast receiver 1402 capable of receiving broadcast signals from a broadcast network, but also an interactive adaptor 1404 capable of accessing an interactive network. The broadcast receiver 1402 receives, from the broadcast network, service data and signaling information such as PSI/SI and ESG. The interactive adaptor 1404 transmits and receives service data or signaling information over the interactive network. A control block 1408 performs a Mobility Management (MM) function of processing handover-related operations by interworking with a Subscription Management block 1410 in charge of management/acquisition of terminal rights relates related to service subscription, and of a decryption procedure for service content. Also, the control block 1408 controls the broadcast receiver 1402 or the interactive adaptor 1404 according to the embodiments of the present invention so that the control block 1408 may receive a normal ESG and a special ESG. When necessary, the control block 1408 receives a key for the special ESG by means of the interactive adaptor 1404, and decrypts the special ESG received by the broadcast receiver 1402, using the key.

At least one of the entities 1402 and 1404 receives the normal ESG and the special ESG over the broadcast network or the interactive network. The received ESGs are used for determining user roaming or service roaming in the control block 1408. Also, the ESGs are delivered to a content consumption block 1412 that provides audio and video of the broadcast service to the user, and then immediately provided to the user, or stored therein so that they can be provided to the user later.

As is apparent from the foregoing description, the present invention generates and provides a special ESG including service guide information for the services available for roaming users, separately for a normal ESG for local users, thereby facilitating efficient support of a roaming procedure for the roaming users.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting an Electronic Service Guide (ESG) for roaming users in a digital broadcasting system, the method comprising:
generating a normal ESG indicating services available for local users in a network;
generating a special ESG indicating services available for roaming users in the network, the roaming users entering into the network from a neighboring network of the network; and
transmitting over at least one of an interactive network and a broadcast network the normal ESG and the special ESG to a terminal in the network.

2. The method of claim 1, wherein the special ESG includes at least one of user roaming service information for a broadcast service available by the roaming users among the services provided by the network, visited service information for a broadcast service provided for the roaming users in the network, and service roaming service information for a broadcast service provided from a home network to which the terminal belongs, the broadcast service being available in the network through service roaming.

3. The method of claim 2, wherein each of the service information includes at least one of identification information for a corresponding broadcast service, an original network identifier, a cell identifier, frequency information for the corresponding broadcast service, right information for the corresponding broadcast service, and charging information for the corresponding broadcast service.

4. The method of claim 1, wherein the normal ESG and the special ESG are transmitted together using a single ESG data model, or transmitted independently using different ESG data models.

5. The method of claim 1, wherein the transmitting step comprises:
encrypting the special ESG, and transmitting the encrypted special ESG over the broadcast network;
receiving from the terminal over the interactive network a request message for the special ESG; and
transmitting to the terminal over the interactive network in response to the request message a key used for decryption the encrypted special ESG.

6. The method of claim 1, wherein the transmitting step comprises:
transmitting the special ESG over the interactive network without encryption.

7. The method of claim 1, further comprising:
after transmitting the special ESG, performing a user roaming procedure or a service roaming procedure according to a roaming proposal from the terminal.

8. A method for receiving an Electronic Service Guide (ESG) for roaming users in a digital broadcasting system, the method comprising:
receiving over at least one of an interactive network and a broadcast network a normal ESG indicating services available for local users in a network and a special ESG indicating services available for roaming users in the network, the roaming users entering into the network from a neighboring of the network; and
performing a user roaming procedure or a service roaming procedure depending on the special ESG.

9. The method of claim 8, wherein the special ESG includes at least one of user roaming service information for a broadcast service available by the roaming users among the services provided by the network, visited service information for a broadcast service provided for the roaming users in the network, and service roaming service information for a broadcast service provided from a home network to which each roaming user belongs, the broadcast service being available in the network through service roaming.

10. The method of claim 9, wherein each of the service information includes at least one of identification information for a corresponding broadcast service, an original network identifier, a cell identifier, frequency information for the corresponding broadcast service, right information for the corresponding broadcast service, and charging information for the corresponding broadcast service.

11. The method of claim 8, wherein the normal ESG and the special ESG are received together using a single ESG data model, or received independently using different ESG data models.

12. The method of claim 8, wherein the receiving step comprises:
receiving over the broadcast network an encrypted special ESG including the special ESG;
sending to the network over the interactive network a request message for the encrypted special ESG; and
receiving over the interactive network in response to the request message a key used for decryption the encrypted special ESG.

13. The method of claim 8, where the receiving step comprises:
receiving the special ESG over the interactive network without encryption.

14. The method of claim 8, further comprising:
selecting the user roaming procedure based on the special ESG when a service expected by each roaming user cannot be received in the network, and selecting the service roaming procedure when the expected service can be received in a visited network.

15. An apparatus for transmitting an Electronic Service Guide (ESG) for roaming users in a digital broadcasting system, the apparatus comprising:
an ESG entity for generating a normal ESG indicating services available for local users in a network, and a special ESG indicating services available for roaming users in the network, the roaming users entering into the network from a neighboring network of the network; and
an interactive network and a broadcast network for transmitting the normal ESG and the special ESG to a terminal in the network.

16. The apparatus of claim 15, wherein the special ESG includes at least one of user roaming service information for a broadcast service available by the roaming users among the services provided by the network, visited service information for a broadcast service provided for the roaming users in the network, and service roaming service information for a broadcast service provided from a home network to which the terminal belongs, the broadcast service being available in the network through service roaming.

17. The apparatus of claim 16, wherein each of the service information includes at least one of identification information for a corresponding broadcast service, an original network identifier, a cell identifier, frequency information for the corresponding broadcast service, right information for the corresponding broadcast service, and charging information for the corresponding broadcast service.

18. The apparatus of claim 15, wherein the normal ESG and the special ESG are transmitted together using a single ESG data model, or transmitted independently using different ESG data models.

19. The apparatus of claim 15, wherein the broadcast network transmits an encrypted special ESG including the special ESG to the terminal, and wherein the interactive network receives a request message for the special ESG from the terminal, and transmits to the terminal over the interactive network in response to the request message a key used for decryption the encrypted special ESG.

20. The apparatus of claim 15, wherein the interactive network transmits the special ESG to the terminal without encryption.

21. The apparatus of claim 15, further comprising a Mobility Management (MM) block for, after transmitting the special ESG, performing a user roaming procedure or a service roaming procedure according to a roaming proposal from the terminal.

22. An apparatus for receiving an Electronic Service Guide (ESG) for roaming users in a digital broadcasting system, the apparatus comprising:
an interactive adaptor and broadcast receiver for receiving over at least one of an interactive network and a broadcast network a normal ESG indicating services available for local users in a network and a special ESG indicating services available for roaming users in the network, the roaming users entering into the network from a neighboring network of the network; and
a control block for performing a user roaming procedure or a service roaming procedure based on the special ESG.

23. The apparatus of claim 22, wherein the special ESG includes at least one of user roaming service information for a broadcast service available by the roaming users among the services provided by the network, visited service information for a broadcast service provided for the roaming users in the network, and service roaming service information for a broadcast service provided from a home network to which each roaming user belongs, the broadcast service being available in the network through service roaming.

24. The apparatus of claim 23, wherein each of the service information includes at least one of identification information for a corresponding broadcast service, an original network identifier, a cell identifier, frequency information for the corresponding broadcast service, right information for the corresponding broadcast service, and charging information for the corresponding broadcast service.

25. The apparatus of claim 22, wherein the normal ESG and the special ESG are received together using a single ESG data model, or received independently using different ESG data models.

26. The apparatus of claim 22, wherein the broadcast receiver receives an encrypted special ESG including the special ESG over the broadcast network, and wherein the interactive adaptor sends a request message for the encrypted special ESG to the network over the interactive network, and receives a key used for decryption the encrypted special ESG, over the interactive network in response to the request message.

27. The apparatus of claim 22, where the interactive adaptor receives the special ESG over the interactive network without encryption.

28. The apparatus of claim 22, wherein the control block selects the user roaming procedure depending on the special ESG when a service expected by each roaming user cannot be received in the network, and selects the service roaming procedure when the expected service can be received in a visited network.
